(19) United States
(12) Patent Application Publication
(10) Pub. No.: US 2017/0374153 A1
(43) Pub. Date: Dec. 28, 2017

(54) DEVICE JOINING GROUP IN A VEHICLE

(71) Applicant: Panasonic Automotive Systems Company of America, Division of Panasonic Corporation of North America, Peachtree City, GA (US)

(72) Inventors: VISHWAS D. KULKARNI, ROCHESTER HILLS, MI (US); YASUHIRO TSUCHIDA, Osaka (JP)

(73) Assignee: Panasonic Automotive Systems Company of America, Division of Panasonic Corporation of North America

(21) Appl. No.: 15/622,703

(22) Filed: Jun. 14, 2017

Related U.S. Application Data
(60) Provisional application No. 62/354,498, filed on Jun. 24, 2016.

(51) Int. Cl. H04L 29/08; H04L 12/26; G07C 5/00

(52) U.S. Cl. CPC H04L 67/12; H04L 67/141; G07C 5/008; H04L 43/16

(57) ABSTRACT

Examples of the present disclosure relate to a device joining system for a vehicle. For example, the system can include a requesting device including a sensor to detect requesting device environmental information and a grouping controller to send the requesting device environmental information to a vehicle server. In an example, the system can include a vehicle server that includes a grouping evaluator to send to the requesting device a join decision. The join decision can be based on a probability calculated from the requesting device environmental information and device environmental information which is detected by a device in the group.

### CROSS-REFERENCED TO RELATED APPLICATIONS

This application claims benefit of U.S. Provisional Application No. 62/354,498 filed on Jun. 24, 2016, which the disclosure of which is hereby incorporated by reference in its entirety for all purposes.

### FIELD OF THE INVENTION

The present disclosure generally relates to a method, system, and device used in a device for joining a group of devices to a communications network. More specifically, the present disclosure relates to devices joining other local devices from inside a vehicle.

### BACKGROUND OF THE INVENTION

This section is intended to introduce the reader to various aspects of art, which may be related to various aspects of the present disclosure, which are described and/or claimed below. This discussion is believed to be helpful in providing the reader with background information to facilitate a better understanding of the various aspects of the present disclosure. Accordingly, it can be understood that these statements are to be read in this light, and not as admissions of prior art.

Vehicles, such as cars, trucks, sport utility vehicles (SUVs), minivans, and boats, among others, can include systems for control or access by occupants. In an example, a vehicle can include a collection of movies that can be played on a vehicle device, wherein the movie can be chosen and selected by an occupant of the vehicle. Other media can be accessed and controlled by an occupant with a device or a plurality of occupants with devices.

The present disclosure presents techniques to add one device to a group of devices within a vehicle or other similar area based on detected environmental information and a comparison of this information to devices already within a vehicle group. For example, a first occupant of a car could have a first smartphone connected to a first group of the vehicle while a second occupant with a second smartphone wishes to join the first group. In an example, a comparison can be made between environmental information collected from the second smartphone and environmental information gathered from the first smartphone. The comparison can be used to return a probability that the second smartphone is in the same car as the first smart phone. The second smartphone may be allowed to join a communications network if the probability exceeded a join threshold.

### SUMMARY OF THE INVENTION

One example can include a device joining system for a vehicle. The system includes a requesting device comprising: a sensor to detect requesting device environmental information; and a grouping controller to send the requesting device environmental information to a vehicle server. The vehicle server comprises a grouping evaluator which sends to the requesting device a join decision, where the join decision is based on a probability calculated from the requesting device environmental information and group device environmental information.

In another example, the requesting device sends a requesting device request to the vehicle server for the requesting device to join a group of the group device. The vehicle server can send an environmental information request to the requesting device for requesting device environmental information and to the group device for requesting group device environmental information, for a period of time. Optionally, the requesting device request includes a requesting device speed-over-ground; and the vehicle server does not send the environmental information request unless the requesting device speed-over-ground corresponds to vehicle speed information.

In an example, the probability can be calculated by comparing a peak value fingerprint of the requesting device environmental information to the peak value fingerprint of the group device environmental information. The sensor can be one of a microphone, an accelerometer, a camera, a light sensor, a global positioning system, a magnetic field sensor, and a gyroscope. The vehicle server can be located outside of the vehicle. The requesting device can include a display to show a prompt for an occupant to generate information detectable as requesting device environmental information and group device environmental information.

The vehicle server sends an environmental information request comprising a time stamp and a time period for collection of the requesting device environmental information and group device environmental information. The join decision is based on a calculation comprising a second group device environmental information from a second group device.

Another example includes a method for detecting, with a sensor of a requesting device, an requesting device environmental information; sending the requesting device environmental information from a grouping controller of the requesting device to a vehicle server; and returning a join decision from a grouping evaluator of the vehicle server, where the join decision is based on a probability calculated from the requesting device environmental information and group device environmental information.

Another example can be a vehicle based, device joining vehicle server. The device can include a grouping evaluator to process received requesting device environmental information from a requesting device, where the requesting device environmental information has been detected by a sensor; and the grouping evaluator to send the requesting device a join decision, where the join decision is based on a probability calculated from the requesting device environmental information and group device environmental information.

### BRIEF DESCRIPTION OF THE DRAWINGS

The above-mentioned and other features and advantages of the present disclosure, and the manner of attaining them, may become apparent and be better understood by reference to the following description of one example of the disclosure in conjunction with the accompanying drawings, wherein:

FIG. 1 is a drawing of an example diagram of a system 100 for a device joining a group in a vehicle;

FIG. 2 is a schematic diagram of an example process 200 for a device joining a group in a vehicle;

FIG. 3 is a method diagram of an example method 300 for calculating environmental information;

FIG. 4 is a drawing of an example data set 400 for environmental information and the identification of peaks for an information fingerprint; and

FIG. 5 is a process flow diagram of an example method 500 for a device joining a group in a vehicle.

Correlating reference characters indicate correlating parts throughout the several views. The exemplifications set out herein illustrate examples of the disclosure, in one form, and such exemplifications are not to be construed as limiting in any manner the scope of the disclosure.

### DETAILED DESCRIPTION OF EXAMPLES

One or more specific examples of the present disclosure can be seen below. In an effort to provide a concise description of these examples, not all features of an actual implementation are described in the specification. It can be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it can be appreciated that such a development effort might be complex and time consuming, and is a routine undertaking of design, fabrication, and manufacture for those of ordinary skill having the benefit of this disclosure.

Presently, when driving with occupants, including family and friends, the occupants can find the time in the car boring. To pass time, occupants of a vehicle can use a device like a smartphone or a tablet individually without conversation. The use of these devices can be limited to individuals, even when all occupants are in the small space of a car.

In the present disclosure, collaboration, sharing, and group forming can provide access to occupants to vote on destination, collaborative contents, screen-sharing, game playing, vote based movie selection and viewing, and so on for an occupant's device. Present methods for how to create a “group” between occupants of a vehicle may not offer all the advantages of the present techniques.

For example, most current social networking service (SNS) apps that offer tools to make a group use at least one person as a leader to make the group. A leader can send invitations to people who intend to join the group. However, in the presently disclosed techniques, a probability that a user device is located within a vehicle can be calculated using location, acceleration, sound and other environmental information, where these measurements can be closer in value if they are being detected in a common car space.

In an example, an occupant's device can request device environmental information with a corresponding timestamp and send it to a vehicle server, such as a server. The vehicle server can compare sets of environmental information to create a group of people that are in close proximity to other occupants. In an example, the calculated probability value may be shown on a passenger's screen graphically. In the present disclosure, a determination of “if” or whether a device can join a group relies on more than simple proximity. Many proximity based joining technologies rely on a simple closeness or a radial distance around a single point or receiver. As presently disclosed, there can be times when another person, pedestrian, passenger of a nearby car or other unwelcome guests may be close enough to join a proximity based communications network relying on proximity alone. Allowing proximity as a sole determinant of access to a network can be dangerous and expose the private matters of a phone or network. Even in moving traffic there can be standstill moments or persistent attempted connections to a proximity based group on an active road. Accordingly, the presently disclosed technology can determine whether a device joining a group is not only proximately located, but also inside a similar environment as a device already joined to the group.

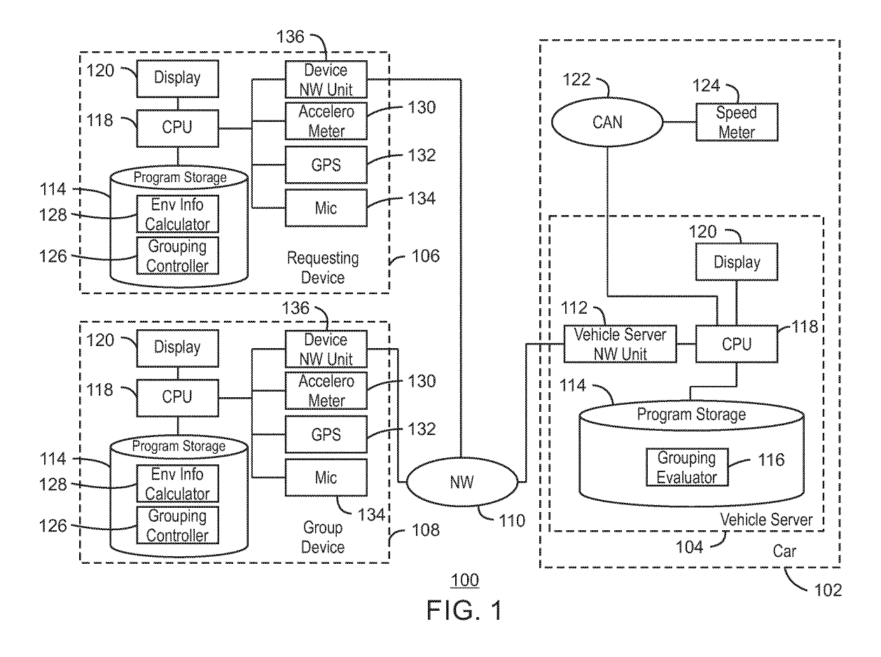

FIG. 1 is a drawing of an example diagram of a system 100 for a device joining a group in a vehicle. FIG. 1 includes a vehicle 102 that can include a vehicle server 104. The vehicle server 104 can be any computer system designated as a top or vehicle server for handling grouping or management of groups in a vehicle. The vehicle server can be inside the vehicle itself, or can be located remote to the car as in a server system that communicates wirelessly with the vehicle. The vehicle server 104 can be connected to a requesting device 106 and a group device 108 through a network 110 through an interfacing vehicle server Network Unit 112. The requesting device 106 and the group device 108 can individually include an occupant device like a smart phone, tablet, laptop, smart watch, virtual reality headset, or any other suitable networking capable electronic device. The requesting device 106 can be the device requesting to join a group while the group device 108 can be a device already joined to the group and located within the vehicle.

The network 110 can be Bluetooth Low Energy (BTLE) or any other suitable personal area network with no need for pairing with the vehicle server for communication. In another example, the network 110 can be high speed data communication protocol like a long-term evolution (LTE) or the requesting device third-generation (3G) networking or other suitable and subsequent networking protocols. The vehicle server 104 can include program storage 114, including the requesting device hard drive storage, a solid-state drive, system memory, circuitry, or any combination thereof requesting a storage device to store a grouping evaluator 116. The grouping evaluator 116 can determine if a requesting device 106 can join the group of a group device 108. Processing for these determinations in the vehicle server 104 can be done by a central processing unit (CPU) 118 located in the vehicle server 104. Results can be displayed on a display 120 of the vehicle server 104. The vehicle server can also be connected through a control area network (CAN) 122 to the components of the vehicle 102 including a speed meter 124 that can determine the current speed of the vehicle 102.

The requesting device 106 and the group device 108 can include their own program storage 114 as discussed above. The program storage 114 of devices such as the requesting device and the group device can store an environmental calculator 128 and a grouping controller 126. In an example, the environmental information calculator can monitor and calculate characteristic values from data received by sensors. In an example, the sensor can be an accelerometer 130, a global positioning system 132, a microphone 134, or another suitable device for measuring external conditions local to the requesting device 106. In an example, the information gathered from the sensors can be refined into environmental information fingerprints that includes peak values of information beyond particular thresholds.

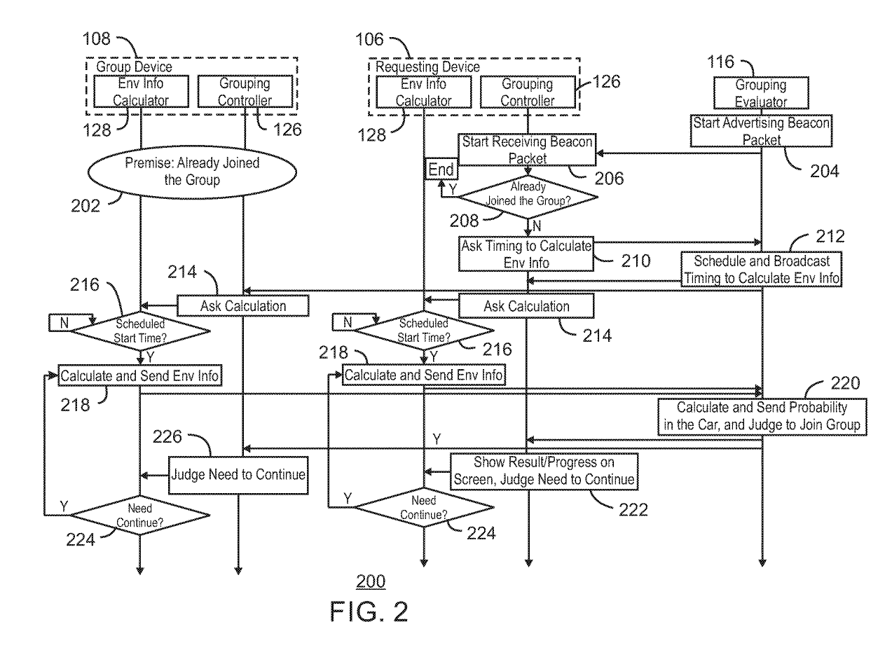

In an example, the grouping controller 126 of the requesting device 106 can send the environmental information or environmental information fingerprint to the vehicle server 104 through a device networking unit 136. The sending of environmental information can be done periodically. In order to reduce a number of transmissions, the grouping evaluator 116 of the vehicle server 104 can be the unit to request the sending of the environmental information. This process can be seen in more detail in FIG. 2. As described above for the requesting device 106, the group device 108 can also include the CPU 118, the grouping controller 126, the environmental information calculator 128, the sensors 130-134, and device networking unit 136. As discussed below with reference to FIG. 2, the comparison of the requesting device 106 received information with the information of the group device can result in the accepting or declining of a join request by the vehicle server 104.

FIG. 2 is a schematic diagram of an example process 200 for a device joining a group in a vehicle. Like numbered items are as described with respect to FIG. 1.

The schematic diagram of FIG. 2 shows the group device 108, the requesting device 106, the grouping evaluator 116, as well as the environmental information calculator 128 and grouping controller 126 of the group device 108 and requesting device 106. The vertical lines proceeding down represent what a particular device is doing at a particular time with the diagram boxes indicating an action or choice going on at the moment. Horizontal lines can represent requests, replies, or general communications between one device and another.

For example, the process begins under the assumption that the group device 108 is already part of the group in step 202. The first device of a group can make the group without this procedure because permission to join the group may proceed if the group is occupied by just one person. Under this assumption, the process of this schematic begins at the grouping evaluator 116, which starts advertising a beacon packet for devices close to a vehicle server 104, as in the example of devices 106 and 108 (step 204). As the group device 108 may already be part of the group, the advertisement may only affect the requesting device 106.

Accordingly, the requesting device 106 can start to receive the beacon packets (step 206). The data requests and communications may be through beacon packets. Once the beacon packets are received by the requesting device 106, a determination can be made as to whether the requesting device 106 may already be part of a particular group sending the message (step 208). If the requesting device 106 belongs to the group sending the packet then the method ends, because the communication line may have already been established. In this scenario, if the requesting device 106 already belonged to the group, then the process could end. If the requesting device 106 does not belong to the group sending the beacon packet, the grouping controller 126 of the requesting device 106 would request to the grouping evaluator 116 of the vehicle server 104 that time information be sent to all devices in a group and to the requesting device 106 itself for a coordinated data gathering to occur (step 210).

Upon receipt of the request from the requesting device 106 and its grouping controller 126, the grouping evaluator 116 could schedule and broadcast a timing to all devices to calculate environmental information over the same time period (step 212). Based on this request in step 212, the requesting device 106 and group device 108 can receive the request and request the environmental information calculators 128 to begin calculating environmental information from the sensors of their own respective device (step 214). At step 216, the environmental information calculator 128 can determine whether the current time is equal to a received start time as indicated by a time stamp received from the grouping evaluator 116. Based on the instructions from the environmental information calculators 128, the environmental information can be calculated and sent back to the grouping evaluator 116 at step 218.

At the grouping evaluator, a calculation of the probability that the requesting device 106 is in the same vehicle as the group device 108 can be made based on the environmental information received. With this information, a grouping evaluator can make a decision as to whether the requesting device 106 can join the group (step 220). The decision can be sent to the group device 108 and the requesting device 106 along with instructions to keep collecting environmental information in case it is needed. The determination to continue gathering information or not can be handled by the grouping controller 126 of the requesting device 106 and group device 108 respectively at step 222 and step 226. If more information is needed, the process can return back to the calculating and sending of environmental information at block 218. However, if there is no more need to continue gathering data, then the devices can proceed based on their current grouping including any recently joined or removed devices of the group for the requesting device and the group device in steps 224.

In a specific example, assume requesting device 106 sends a request to join the group of group device 108 at timestamp 10:21:30 to the grouping evaluator 116, as shown in step 210. In response, the grouping evaluator 116 can broadcast to the requesting device 106 and the group device 108 to start calculating environmental information starting at a timestamp in the future, e.g., 10:21:33.000, as shown in step 212.

In response to this request, the devices within range of the grouping evaluator can calculate their particular environmental factors during time stamp 10:21:33.000 as shown in step 216, and can send the results back to the vehicle server 104 and the grouping evaluator 116, as shown in step 218. The grouping evaluator 116 can compare all the environmental information from the time stamp 10:21:33.000 from the devices in the vehicle 102 and determine whether requesting device 106 probably resides within the vehicle 102 based on a comparison to data from group device 108 from the same time stamp, as shown in step 220.

For increasing security, e.g., to avoid a malicious user joining the group, a grouping evaluator 116 can cancel any judgment of grouping or cancel/reschedule a request for environmental information when a vehicle speed may be lower than a certain speed, when the vehicle may be stopped or stopping. Using this mechanism may lead to a reduction in attempted joining to a communications network based solely on proximity while idling at a red light, waiting in a parking lot, or preparing to arrive at a destination (e.g., braking). These measurements can be obtained from the connected speed meter 124 of the vehicle 102 or by measurement of whether a vehicle 102 has its brakes applied. In another example, the request for devices to join or calculate environmental information could be limited to devices with a corresponding speed when comparing a detected speed from a global positioning system (GPS) of the device to the speed meter 124 or GPS of the vehicle 102.

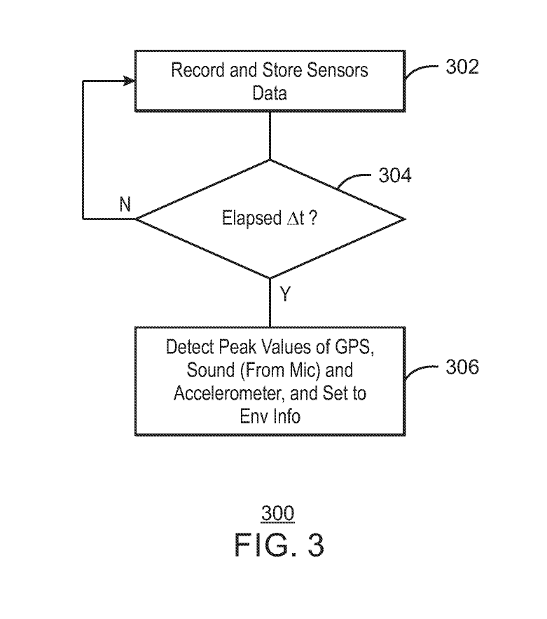

FIG. 3 is a method diagram of an example method 300 for calculating environmental information. Process flow begins at block 302. At block 302, an environmental information calculator can record and store sensor data from the local sensors of a device. As discussed above, these sensors can include a microphone, an accelerometer, a global positioning system, a magnetic field detector, a barometer, a gyroscope, or any other suitable sensor for measuring local conditions. As discussed above, the collection of this environmental information can begin across devices at a certain time stamp.

At block 304, a determination can be made as to whether enough collection time (Δt) has yet elapsed. If not, the environmental information calculator 128 continues to record requesting device environmental information. If yes, the process flow proceeds to block 306.

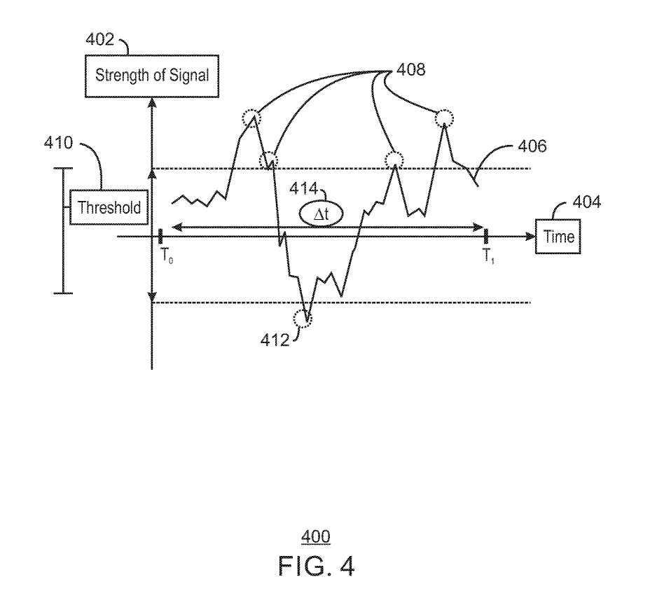

At block 306, the peak values of sensor data can be detected. As discussed above, these sensor values can include GPS data, sounds from a microphone, and information from an accelerometer. Further, the detection of peak values allows for a fingerprint of the environmental information data to he formed, rather than all the data being transferred and used as a basic comparison to other potentially nearby devices. Further detailing of the fingerprinting of environmental information can he seen in FIG. 4.

FIG. 4 is a drawing of an example data set 400 for environmental information and the identification of peaks for an information fingerprint. The y-axis shows a hypothetical strength of a signal 402, while the x-axis shows a hypothetical time 404 over which the signal may have been transmitting. The signal 406 may be a detected soundwave or light intensity or any other signal capable of having peaks 408. The peaks can be any points that exceed, in absolute value a particular threshold 410 on the y-axis indicating there are particular points of a strongest strength of signal. Further, while a low point 412 can be below a threshold, the signal can count the lowest point in a signal as trough. The use of peaks and troughs in a fingerprint can help identify a particular environmental information signal. In an example, a fingerprint can instead assume that an absolute value of signal strength can be used rather than positive and negative values of signal intensity. Thus, point 412 can be considered a peak for the purposes of generating a peak value fingerprint for a particular device. Additionally, before detecting peak values, a low pass filter can be applied to the signal to remove noise within a particular threshold.

These peaks may be measured for a time duration (Δt) 414 such that T₀ indicates a time stamp to begin collecting or calculating peak data for an environmental information fingerprint. The end time of collection can be T₁. Further detailing of an example means for calculating peak values to get a fingerprint of the environmental information can be seen in the description and example equation (Equation #1) below.

$$P = min ( {\sum }_{i = 1}^{N} {α}_{i} \times Diff ( {D}_{i , G} , {D}_{i , j} ) , 1 ) \\ calculating probability ( P ) a device is in a vehicle \qquad Equation 1$$

Equation 1 shows one example of how to calculate a probability (P) that a device may be in the car, where the probability value can be a value from 0 to 1.

In an example, the probability (P) can also be calculated by convolving difference of two devices' datasets, where one is a device G which has already joined a group and the other is a device j which want to join the group. The datasets used, e.g. (D_{i,j}) can be recorded with a sensor sᵢ (in set S=[s₀, s₁, . . . , s_{N}], where s* is, for example, s₀=GPS data, s₁=microphone data, s₂=Accelerometer data) of a device j as [(s_{i,1}, t₁), (s_{i,2}, t₂), . . . , (s_{i,k}, tₖ)] where sᵢₖ is k^{th} recorded value and tₖ is time sᵢₖ was recorded. The example of Equation 1 can also include αᵢ, which can be a weight coefficient of sensor Sᵢ from 0 to 1 to emphasize one sensor over another. If P=0, this can mean that device j can be in a vastly different place from device G, while P=1 can mean a very high probability of device j and device G sharing the same space, perhaps within a same vehicle.

In the example Equation 1 above, the Diff(a, b) function can show a magnitude of difference between dataset a and b. For example, Diff(a, b)=0 when a and b may be completely different, while Diff(a, b)=1 when a and b may be the same. The Diff(a, b) can be calculated through plotting the datasets a and b on s-t plane, painting all rectangle of (s_{i,x-1}, tₓ₋₁)−(s_{i,x}, tₓ)−(0, tₓ)−(0, tₓ₋₁) of a and b, summing the areas of the painted surfaces that are not overlapped with each other as SUM_{ab}. Then, the Diff(a, b) is calculated as 1−(SUM_{ab}/SUMₐ), where the SUMₐ is summed area of painted by datasets a. In an example, whether device j can join the group may be determined by whether P>=Pₜₕᵣₑₛ, where Pₜₕᵣₑₛ is a threshold value, such as 0.75. Further, if no devices are in a group, a request may automatically be approved.

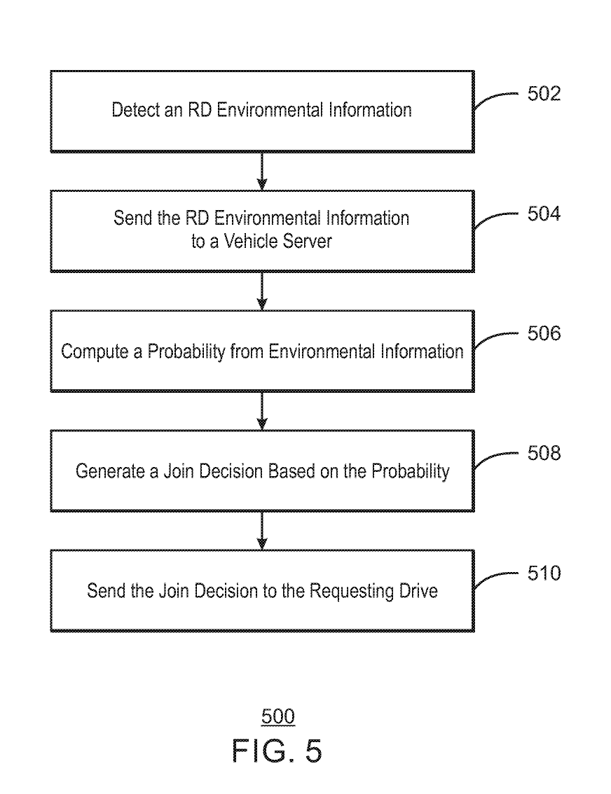

FIG. 5 is process flow diagram of an example method 500 for a device joining a group in a vehicle. Process flow begins at block 502.

At block 502, a sensor of a requesting device can detect requesting device environmental information. The requesting device environmental information can be full environmental information and can also be an environmental information fingerprint as described above.

At block 504, the requesting device environmental information can be sent from a grouping controller of the requesting device to a vehicle server. As discussed above, at the vehicle server a probability that the requesting device is in the same vehicle as another device can be determined through a probability calculation made in the vehicle server by a grouping evaluator.

At block 506, a probability that the requesting device is in the same vehicle as the group device is calculated. At block 508, a join decision can be generated by a grouping evaluator of the vehicle server, where the join decision is based on a probability calculated from the requesting device environmental information and group device environmental information. At block 510, the join decision can be returned to the requesting device. Once a join decision returns, the requesting device can show the result of the join decision gaphically.

In an example, this can be graphically displayed on a display of the requesting device. In an example, a graphical user interface can prompt an occupant to generate detectable information including a prompt such as “say something”, or “sing something” to increase “probability in a car.” The making of a noise or using of a voice by an occupant in the car can greatly increase a probability of being in a car when the noise or voice leads to or accompanies a join request as an occupant voice may occupy a large part of a signal, or signal peaks by devices in the car. Accordingly, an occupant making a purposeful noise during an environmental information gathering session can be expected to increase the computed probability of being in a car (P).

What is claimed is:

1. A device joining system for a vehicle, comprising:
a vehicle server comprising a grouping evaluator;
a requesting device comprising:
a sensor to detect requesting device environmental information; and
a grouping controller to send the requesting device environmental information to the vehicle server;
wherein the grouping evaluator computes a probability from the requesting device environmental information and group device environmental information, generates a join decision based on the probability, and sends the join decision to the requesting device.

2. The system of claim 1, wherein the requesting device sends a requesting device request to the vehicle server for the requesting device to join a group of the group device.

3. The system of claim 2, wherein the vehicle server sends an environmental information request to the requesting device for requesting device environmental information and the group device for group device environmental information, for a period of time.

4. The system of claim 3, wherein:
the requesting device request includes a requesting device speed-over-ground; and
the vehicle server does not send the environmental information request unless the requesting device speed-over-ground corresponds to vehicle speed information.

5. The system of claim 1, wherein the probability is calculated by comparing a peak value fingerprint of the requesting device environmental information to the peak value fingerprint of the group device environmental information.

6. The system of claim 1, wherein the sensor is one of a microphone, an accelerometer, a camera, a light sensor, a global positioning system, a magnetic field sensor, and a gyroscope.

7. The system of claim 1, wherein the vehicle server is located outside of the vehicle.

8. The system of claim 1, wherein the requesting device comprises a display to show a prompt for an occupant to generate information detectable as requesting device environmental information and group device environmental information.

9. The system of claim 1, wherein the vehicle server sends an environmental information request comprising a time stamp and a time period for collection of the requesting device environmental information and group device environmental information.

10. The system of claim 1, wherein the join decision is based on a calculation comprising a second group device environmental information from a second group device.

11. A method for joining a device to a group, comprising:
detecting, with a sensor of a requesting device, requesting device environmental information;
sending the requesting device environmental information from a grouping controller of the requesting device to a vehicle server; and
computing a probability, with a grouping evaluator, based on the requesting device environmental information and group device environmental information;
generating a join decision based on the probability; and
sending the join decision to the requesting device.

12. The method of claim 11, wherein the requesting device sends a requesting device request to the vehicle server for the requesting device to join the group.

13. The method of claim 12, wherein the vehicle server sends an environmental information request to the requesting device for requesting device environmental information and the group device for group device environmental information, for a period of time.

14. The method of claim 13, wherein:
the requesting device request includes a requesting device speed-over-ground; and
the vehicle server does not send the environmental information request unless the requesting device speed-over-ground corresponds to vehicle speed information.

15. The method of claim 11, wherein the probability is calculated by comparing a peak value fingerprint of the requesting device environmental information to the peak value fingerprint of the group device environmental information.

16. The method of claim 11, wherein the sensor is one of a microphone, an accelerometer, a camera, a light sensor, a global positioning system, a magnetic field sensor, and a gyroscope.

17. The method of claim 11, wherein the vehicle server is located outside of a vehicle.

18. The method of claim 11, wherein the requesting device comprises a display to show a prompt for an occupant to generate information detectable as requesting device environmental information and group device environmental information.

19. The method of claim 11, wherein the vehicle server sends an environmental information request comprising a time stamp and a time period for collection of the requesting device environmental information and group device environmental information.

20. The method of claim 11, wherein the grouping evaluator sends to the requesting device a calculated probability, wherein the probability comprises a calculation based on a second group device environmental information from a second group device.

21. A vehicle based, device joining vehicle server comprising:
a grouping evaluator to process received requesting device environmental information from a requesting device, where the requesting device environmental information has been detected by a sensor; and
the grouping evaluator to send the requesting device a join decision, where the join decision is based on a probability calculated from the requesting device environmental information and received group device environmental information.

22. The vehicle of claim 21, wherein the received requesting device environmental information comprises a requesting device request to join a group of the group device.

23. The vehicle of claim 22, wherein the vehicle server sends an environmental information request to the requesting device for requesting device environmental information and the group device for group device environmental information, for a period of time.

24. The vehicle of claim 23, wherein:
the received requesting device request comprises a requesting device speed-over-ground; and
the vehicle server does not send the environmental information request unless the requesting device speed-over-ground corresponds to vehicle speed information.

25. The vehicle of claim 21, wherein the probability is calculated by comparing a peak value fingerprint of the requesting device environmental information to the peak value fingerprint of the group device environmental information.

26. The vehicle of claim 21, wherein the sensor is one of a microphone, an accelerometer, a camera, a light sensor, a global positioning system, a magnetic field sensor, and a gyroscope.

27. The vehicle of claim 21, wherein the vehicle server is located outside of the vehicle.

28. The vehicle of claim 21, wherein the vehicle server sends a signal to a requesting device for a display to show a prompt for an occupant to generate information detectable as requesting device environmental information and group device environmental information.

29. The vehicle of claim 21, wherein the vehicle server sends an environmental information request comprising a time stamp and a time period for collection of the requesting device environmental information and group device environmental information.

30. The vehicle of claim 21, wherein the grouping evaluator sends to the requesting device a calculated probability, wherein the probability comprises a calculation based on a second group device environmental information from a second group device.
